(19) United States
(12) Patent Application Publication
(10) Pub. No.: US 2015/0335974 A1
(43) Pub. Date: Nov. 26, 2015

(54) Greenwall exercise power generation station

(71) Applicant: Lucie T. Levesque, Hearst (CA)

(72) Inventor: Lucie T. Levesque, Hearst (CA)

(21) Appl. No.: 14/545,403

(22) Filed: May 1, 2015

Related U.S. Application Data
(60) Provisional application No. 61/996,533, filed on May 12, 2014.

(51) Int. Cl. A63B 69/00; F03G 5/08; H02K 7/18

(52) U.S. Cl. CPC A63B 69/0048; H02K 7/1861; F03G 5/08

(57) ABSTRACT

The urgent need to reduce our dependence on fossil fuels and the resulting global sedentary lifestyles of mankind makes this innovation a win-win solution to reduce our carbon footprint in a fun, safe and novel way. The energy output of the rotating wall or ladder is estimated to be ten times more efficient than the output of existing cycling, elliptical or stepping stations because the total weight of the climber is used instead of pedal (leg) power that can only tolerate an average of 2 kg of resistance. Climbing stations will be used to feed batteries, to convert power for internal use or feed electricity back to the grid. These power stations will soon become standard electric car charging stations and school, military, home or fitness center apparatus. Climbing teams will compete to produce maximum energy output. Recreation of energy at its best!

### 1.0 SUMMARY OF THE INVENTION

### 1.1 Brief Description of the Invention

The invention, Green Wall exercise power generation station, aims to produce electrical energy through the physical exercise of climbing a wall.

The system converts the kinetic energy of the movement and weight of a climber climbing an endless rotating vertical climbing belt into rotary motion of the induction generator which then converts it into clean electrical energy. The amount of energy produced depends on the mass of the climber and the climbing speed. Existing vertical climbing walls used in the fitness rooms cannot produce energy.

Kinetic energy KE due to translation is given by formula:

KE=0.5*m*v²

### Where:

KE=Kinetic Energy [Joule=1Kg*m²/s²]
M=mass of the climber [Kg]
V=speed of climber [m/s]
With an average mass of climber at 75 Kg and climbing speed 6.26 m/s,

### Kinetic Energy KE=0.5*75*6.26*6.26=1471 Joule

The amount of Potential Energy

P.E.=m*g*h

### Where:

P.E.=potential energy
m=mass of the climber [Kg]
g=acceleration of gravity [9.81 m/s²]
m=mass of the climber [Kg]
g=acceleration of gravity [9.81 m/s²]
h=2 m-maximum height position of climber from ground on the wall [m]

P.E.=75*9.81*2=1471 Joule

If a device converts one Joule of energy every second the power is 1 Watt.

The Watt is a unit of power that is equal to one Joule of energy being converted every second.

### 1 Watt=1 Joul/second

Power is the rate at which energy is being converted from one form into another.

### Power=Work/time=Joule/second=Watt

### Power=Joule/second

Power=1471/1=1471 watt

Total mechanical energy of the system is altered by frictional forces which oppose the motion of the climber having negative value. The final mechanical energy will be less due to the energy loss of kinetic friction.

Taking into account total losses in this process due to slippage, friction and heat in the winding resistance, approximate 471 watts) potential energy generated by the mass of climber and gravity after overcoming these losses resulted from the Green Wall is estimated to be:

Green Wall exercise generation station Power=1000 watts=1 KW

The new design concept of the Green Wall exercise power generation station is a simple modular design with multiple options use, including all electrical modular components to convert kinetic energy into electrical energy.

### 1.2 Field of Invention, Definitions, Terms, Elements

The Green Wall exercise power generation station relates to a power generating device operated by the body weight of a climber and gravity. The Green Wall exercise power generation station is used for physical exercise and to capture and convert the kinetic energy resulted from the body weight of the climber and gravity into electrical energy.

The Green Wall exercise power generation station includes the structural frame modular design with the top and bottom roller and endless belt surface on which the climbing holds are attached.

Belt moving speed is controlled by an electronic system with emitter and receiver to detect the climber, a microprocessor for speed control and braking safety control.

Two transmissions pulley timing belt systems (power transfer mechanism), are used to transfer and increase the rotational speed to the generator's shaft.

Double fed induction generator is used with primary function to convert mechanical energy into electricity has the stator connected to the grid using converters AC and DC. Charge controller, inverter AC to DC, batteries, inverter DC to AC with connection to the breaker panel and meter to the grid are also included.

### 2.0 BACKGROUND OF THE INVENTION

The information contained in this document is confidential

This invention relates to the Green Wall exercise power generation station using the weight of the climber and gravity. Mechanical energy source given by the climber weight and gravity connected mechanically to the rotor through a belt pulley systems, and able to generate a mechanical driving torque for driving the rotor's shaft of the generator converting it in electrical energy. One object of the present invention is to provide a system for capturing and harnessing mechanical energy of a wall climber and convert into electrical energy for internal use or returned back to the grid. The invention can be used in any location for physical exercise to produce electrical energy to an affordable extent without any consumable material resources or pollution.

The invention aims to produce electrical energy through the physical exercise of climbing a wall.

### 2.1 PATENT CITATIONS

Title: Method and apparatus for converting human power to electrical power

### Cited Patent: US20130049374A1

Filing date: Jul. 3, 2007
Publication date: Mar. 17, 2009

### Applicant: Linda A. Vasilovich, Richard K Hilgner

### 3.0 DESCRIPTION OF THE INVENTION

### 3.1 Brief Description

In FIG. 2 the Green Wall exercise power generation station assembly shown the structural frame (1), (2) with top roller (4) and bottom rollers (5) and pulley shaft (6) for moving belt wall (3). The belt is tensioned using a take-up bearings (8) for the bottom roller (5). On the belt wall surface climbing holds (18) are fastened to a specific climbing pass using two screws with flange nuts. Top roller (4) is supported by two flange self-aligning low friction bearings (28). Bottom roller (5) has attached on it a driving pulley (23) and the disc brake (9) with brake pads (14) to control the moving wall speed using the sensors. The frame is installed on a flat floor using anchor expansion bolts (28) to secure the frame in place. The two timing belt pulley (26) transmission systems, first including bushings (21), (22) and pulleys (23), (25) and the second including bushings (21), (22) and pulleys (23), using lower friction bushing (24) and (25) with the shaft (6) installed on bearing housing (10) will increase the mechanical rotation speed. The transmission belt system have a drive guard (15) and (16). With a holder assembly (18).The frame has on each side lateral covers (11), (12) and bottom lateral cover (13) to keep inside area of belt wall closed. All hard exposed parts of the frame are protected with foam mats protection (19) for safety reasons. The induction generator (20) mounted on a bracket (7) needs a reasonable amount of reactive power which must be fed externally to establish the magnetic field necessary to convert the mechanical power from the shaft into electrical power. Double fed induction generator (20) is a wound rotor machine where the rotor circuit is connected to the external variable frequency source via slip rings, and the stator is connected to the grid network. The induction generator converts mechanical energy into electrical energy which can be transmitted to a load or returned to the grid.

### 3.2 DRAWINGS FIGURES

In the accompanying drawings, which illustrate certain adaptations of the invention as applied to Green Wall exercise power generation station are included in the Appendix A, B, and C.

FIG. 1 is a schematic drawing of Green Wall exercise power generation station showing its main block components. FIG. 2 is an axial section of Green Wall exercise power generation station general assembly showing its working parts. FIG. 3 is a 3D view of the Green Wall exercise power generation station showing all components of the assembly as 3D view.

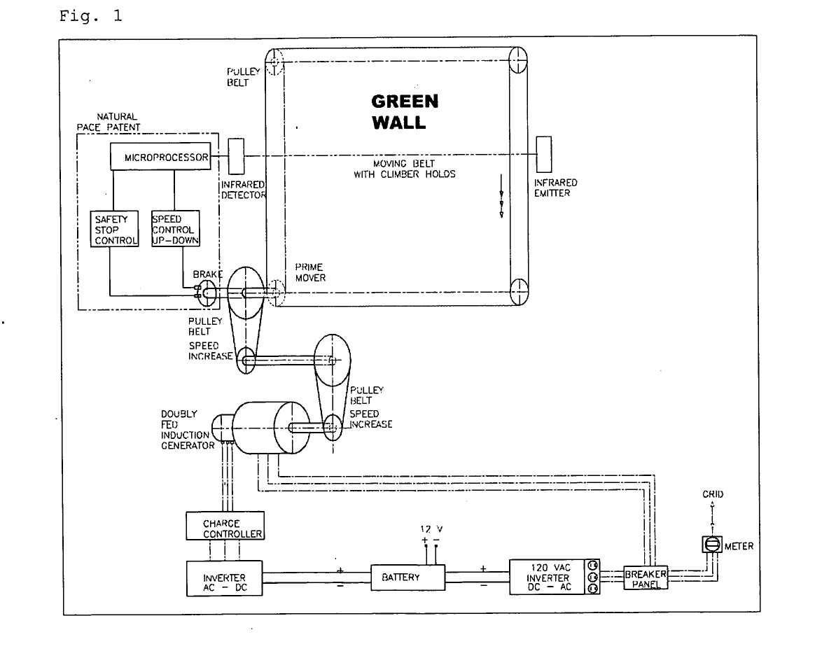

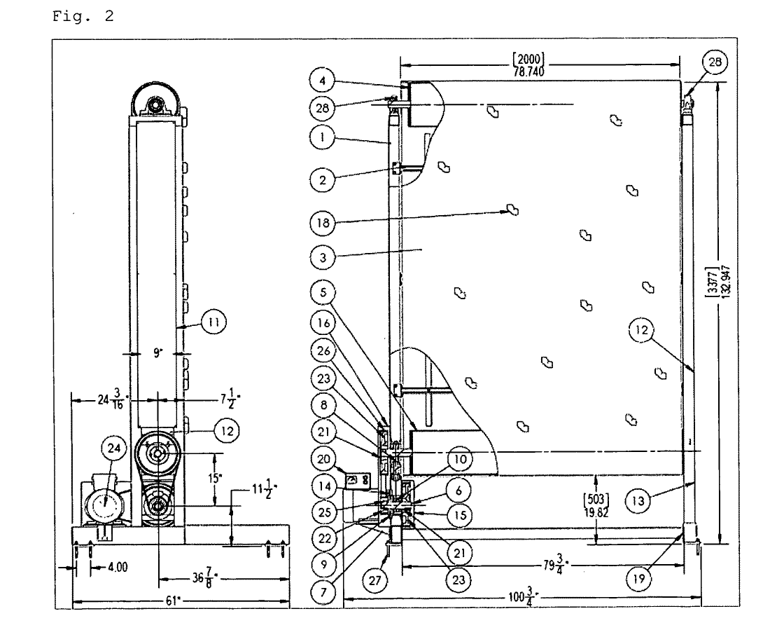

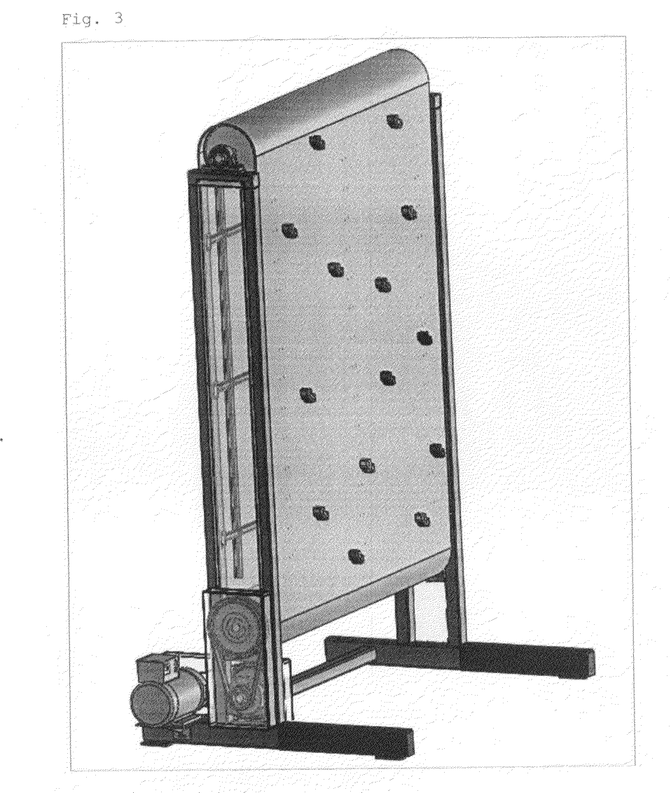

In FIG. 1 the Green Wall exercise power generation station main components are shown including moving belt with climber holds distributed on the surface to a specific climbing pass, which is controlled by an electronic system for controlling the moving speed, two transmissions pulley timing belt systems, double fed induction generator with charge controller, inverter AC to DC, batteries, inverter DC to AC with connection to the breaker panel and meter to the grid.

### 3.3 DETAILED DESCRIPTION

According to the main feature of the invention, Green Wall exercise power generation station is used to convert mechanical energy into electrical energy by a generator. The green wall for climbing is built from an endless belt with two rollers; one support idler roller at the top, and one driven roller at the bottom. The linear movement of the belt is converted in rotation of the bottom roller shaft and pulley. A system consisting of two timing belt pulley transmissions are used to obtain substantial speed multiplication of the small pulley installed on the rotor shaft of generator. The system increases the rotation speed, and transfers the driven roller rotation to the shaft of the electrical generator.

The generator converts the mechanical energy into electrical energy, creating electrical current that is transmitted to a load or stored into batteries. An inverter can be used which converts DC into AC power. To establish the magnetic field necessary to convert the mechanical power from the generator's shaft into electrical power a reactive power is supplied by an electric inverter connected to the grid.

For stand-alone generator a capacitor shall be used to provide excitation to the machine' rotor. With capacitor the system is called SEIG (self-excited induction generator). A lower speed machine will require a larger capacitor. The magnetized rotor moving past the windings generates voltage in the windings. The machine voltage and frequency are determined by how many turns are in the windings, how fast the rotor turns, and how much load is applied to the generator.

When reactive power is used by an inverter connected to the grid network the system is called DFIG (Double-fed induction generator). The rotor circuit is connected to the external variable frequency source via slip rings, and the stator is connected to the grid network. Through a smart electronics varying AC frequency is controlled, so that a relative fixed output voltage and frequency can be achieved despite the varying speed of the shaft rotor.

The generator's angular speed is fixed by the grid's frequency, and the power output is determined by the torque applied to the generator's shaft.

The Green Wall exercise power generation station can produce considerable electrical energy using body weight and gravity, which can be stored using batteries, converted for internal use or returned to the grid. The electrical energy from the electrical generator is stored to a set of 12V batteries and converted using invertors to be returned back to the grid. The Green Wall exercise equipment generates energy which can be sent to the grid by simply plugging the standard Plug-Out outlet.

Climbing surface is a custom made endless belt with climbing holds. The belt surface has a series of holds set up for climber to follow called a “route.” The holds grips are bolted to the belt wall and distributed over the belt surface fairly evenly with the most positive surface facing up near the center of the belt. The colors can be used to set a “route.” A motion tracking system of the climber is based on radio frequency (RF), and typically employs a receiver and transmitter. Sensors are placed on both sides at specific heights which transmit and receive beam signals. The sensors stops the belt using a brake system when the climber stops or reaches the top, and release the brake when the climber is moving upwards.

At the base of the climbing wall the landing is covered the entire length of the wall with mats flooring at min 2.5″ thick. All other hard surfaces are protected with foam mats for safety reasons.

### 3.4 Alternate Embodiments

The embodiments of the invention in which an exclusive property or privilege is claimed are defined as follows:

We claim:
1. Green Wall exercise power generation station-alternative energy created using gravity/total body weight of climber.
2. The Green Wall exercise power generation station unique modular design for physical exercise.
3. The Green Wall exercise power generation station of claim 1 wherein said is constructed of modular elements for adaptability and flexibility.
4. The Green Wall exercise power generation station provide electrical energy by simply using a generator to convert mechanical energy from physical exercise of a wall climber into electrical energy.

### 3.5 ADVANTAGES OF THE INVENTION

The invention related to Green Wall exercise power generation station serves as climbing apparatus as well as providing green electrical energy for local use or to return to the grid. Simple construction, low cost, pollution free generator solves electrical power needs to an affordable extent. The Green Wall EPGS is estimated to be ten times more efficient at generating alternative energy because the mechanical force applied to turn the drive shaft is constant and linear unlike rotational or elliptical mechanical energy outputs of exercise equipment presently available on the market.

1. The Green Wall Exercise Power Generation Station (GW-EPGS) to create considerable amount of alternative energy by using the constant gravity pull on the total weight of the climber(s) escalading the rotating wall or ladder; by applying maximum gravitational linear force directly above the drive shaft connected to a high torque-low rpm motor to convert the physical activity of the climber who maintains a relative position above the rotating shaft that feeds the constant gravitational pull from mechanical energy of climbing into electrical energy consisting of a generator connected to the exercise machine as disclosed in the detailed descriptions and drawings of the GW-EPGS Patent Specification document.

2. The Green Wall (GW-EPGS) of claim 1 is a unique modular design exercise power generation station for a fun, safe and low-impact cardio-vascular climbing physical activity wherein said can be substituted and adapted with existing rotating walls or ladders where the mechanical energy of the climber(s) applied is equal to the total weight of the climber(s) and used to predict and estimate potential energy output of alternative energy output.

3. The Green Wall Exercise Power Generation Station (GW-EPGS) of claim 1 wherein said is constructed of modular elements for adaptability and flexibility like optional climbing surface knobs or ladder style holds for the climber to step and grab on to.

4. The Green Wall Exercise Power Generation Station (GW-EPGS) of claim 1 to provide significant electrical energy by simply using a generator to convert mechanical energy from the physical exercise of climbing into electrical energy; to use or send the electrical current that is transmitted to a load or into batteries and to power the station's electronic displays and the alternative energy produced by the climber (s) in watts and time in minutes.
